(19) United States
(12) Patent Application Publication
(10) Pub. No.: US 2006/0292279 A1
(43) Pub. Date: Dec. 28, 2006

(54) Method for the selective separation of volatile flavorings from monophase, (semi) liquid starting materials having a fat content and/or oil content of = 20 percent by weight

(76) Inventors: Johann Wiesmuller, Garching (DE); Erwin Schutz, Trostberg (DE); Rudolf Zobel, Willanzheim (DE)

Correspondence Address: FULBRIGHT & JAWORSKI, LLP, 666 FIFTH AVE, NEW YORK, NY, 10103-3198, US

(21) Appl. No.: 10/533,770

(22) PCT Filed: Nov. 7, 2003
(86) PCT No.: PCT/EP03/12466

§ 371 Date: May 4, 2005

(30) Foreign Application Priority Data
Nov. 9, 2002 (DE) 102 52 168.9

(51) Int. Cl. A23L 1/22

(52) U.S. Cl. 426/534

(57) ABSTRACT

Disclosed is a method for the selective separation of volatile flavorings from monophase, (semi)liquid starting materials having a fat content and/or oil content of =20 percent by weight, said method being preferably carried out at temperatures of =70 ° C. and at pressures of <50 MPa, especially by using compressed ethane, propane, butane, or any mixtures thereof. The starting materials can be pastes and purees having a fluid content of =10 percent by weight and water-containing and/or alcohol-containing liquids, especially juices and waters obtained during the production of juice, as well as alcoholic beverages and hard liquors. The inventive method makes it possible to obtain particularly separated natural, nature-identical, and/or artificial flavorings of high sensory qualities while undesired flavorings can be removed from the starting materials, i.e. said starting materials can be deodorized.

### DESCRIPTION

The present invention relates to a method for the selective separation of volatile flavorings from monophase, (semi)liquid starting materials having a fat content and/or oil content ≦20% by weight.

Modern food technology makes use of a variety of methods for processing foods in order to be able to offer consumers products which are up to date and appropriate to altered eating habits. In the case of some method steps, the original flavor of the starting materials, however, is changed technologically and is also frequently adversely affected, because, in particular, valuable flavorings are removed. Since, however, it is precisely the sensory properties of the products which is a critical quality criterion, it is an aim of food technology to compensate for this processing-related impairment of the products by targeted addition of flavorings. Owing to increasingly critical consumer attitudes, primarily natural flavorings which are produced from natural sources are preferred for this to nature-identical, or especially artificial flavorings.

However, from the technological aspect, producing flavorings from natural materials is frequently very problematical, because, firstly, the actual typical sensory impression is determined by the interaction of a multiplicity of individual compounds, but secondly many flavoring components are compounds which, as a result of processing, and especially by thermal stress, are destroyed, or, owing to their high volatility are unintentionally removed.

This problem is very pronounced, especially in the production of flavorings from fatty or oily natural substances. In addition, in the case of some of these raw materials, attempts are made to produce flavoring fractions which have fat and/or oil contents as low as possible, as is an essential precondition, in particular, for producing in part water-soluble instant preparations, for example instant coffee or products having a reduced fat/oil content, those termed Light products.

For producing flavorings from fatty and oily natural substances, numerous methods are already known. In addition to the classic distillation methods, for example fractional distillation or steam distillation, many conventional solvent methods are also used.

Very recently, numerous methods have also been described in which the flavorings are extracted by compressed gases, in particular by supercritical carbon dioxide. As an example, at this point, reference may be made to European patent EP 0 065 106, in which a method is described for producing concentrated aroma and flavor extracts by extraction with carbon dioxide at supercritical pressure and subcritical temperature. These methods are currently of great interest, in particular owing to their gentle process conditions and the high selectivity of the solvent, since with their help, very high-grade quality aromas can be produced.

In this method, various method paths can be taken to separate a fat/oil fraction from an aroma fraction. Firstly, fractional extraction is suggested, in which the different constituents are sequentially extracted from the natural material by different method parameters, such as pressure, temperature or entrainer feed, and are collected separately. Secondly, fractional precipitation comes into question, in which, although the different constituents are first extracted jointly, they are then precipitated from the gas under different conditions.

Experience shows, however, that both types of methods are frequently burdened with disadvantages: for instance, in the fractional extraction using compressed carbon dioxide, it is frequently not possible to extract effectively the fats or oils from the flavorings separately, since both classes of substance, under identical conditions, exhibit similar solubility in carbon dioxide. In the case of fractional precipitation, also, it is true that effective separation of the flavorings from fat and oil can frequently only be carried out poorly, because the solubility behavior of the two classes of substance in compressed carbon dioxide differ too little. Although, by additional processing measures, for example charging aids in the extract separator, it is possible to achieve improvements, frequently satisfactory enrichment of the aroma constituents is not achieved, since these are still present in a lipophilic matrix to a considerable extent. Producing aromas having a low fat and/or oil content which are suitable, in particular, for aromatizing instant drinks or Light products, is therefore frequently only possible inadequately using aroma fractions produced in this manner.

Attempts have therefore also been made, for the production of natural flavorings, to precede the pure CO₂ extraction with extraction with liquid propane and/or butane in order by this means to separate selectively the oil and fat components which are very critical in sensory terms, and only subsequently to carry out the actual aroma extraction (DE-A 44 40 644).

In this method which is carried out in the first stage at temperatures ≦70° C. and at pressures ≦50 MPa, however, it is proved that in the industrial implementation, it can only be carried out using solids, and in addition, only in the case of natural materials which comprise natural flavorings at high concentration. Successful aroma extraction of liquid and semiliquid (viscose) starting materials and those having a low flavoring content, however, is not possible using this two-stage method.

From these disadvantages of the known prior art, the present invention has therefore been set the object of providing a method for the selective separation of volatile flavorings from monophase, (semi)liquid starting materials having a fat content and/or oil content ≦20% by weight which makes it possible to separate especially the readily volatile flavorings from the starting material in a manner such that primarily flavorings in highly concentrated and high sensory quality are obtained, but, secondly, also to free the starting materials from volatile substances having adverse aroma notes, in which case the method to be used should be simple to implement technically and further downstream purification of the separated flavorings or of the dearomatized starting materials would be unnecessary.

This object has been achieved by a method for the selective separation of volatile flavorings from monophase, (semi)liquid starting materials having a fat content and/or oil content ≦20% by weight, which is characterized in that it is carried out using compressed C₂- to C₄-hydrocarbons.

Completely surprisingly, on converting the inventive method to the industrial scale, it proves that, despite the known selective properties of hydrocarbons toward fat and/or oil constituents, the volatile flavorings are obtained selectively from the (semi)liquid starting material and in addition the separated-off flavorings are obtained in qualities which come close to or even correspond to what is termed the WONF standard (without other natural flavor). Possible oily and/or fatty components of foreign aroma are completely discriminated against in this separation method and remain selectively in the starting material. On the other hand, it was surprising that using this simple method, even (semi)liquid, that is to say relatively high-viscosity and high-viscosity starting materials, can be freed from aroma notes which leave behind an adverse sensory impression, as a result of which the starting material can be enhanced in quality.

Using the inventive method, it is thus possible not only to produce desired flavorings from a liquid or semiliquid starting material, but also to separate unwanted flavorings from a liquid or semiliquid starting material.

In addition, using this method it is also possible to separate selectively volatile flavorings from alcoholic liquids, which is very readily possible in particular with wine and wine-containing drinks, which was not to be expected, especially, because alcohols, as lipophilic components, are usually very well dissolved by hydrocarbons, and thus would actually have to be separated together with the aroma fractions. This also does not happen, however, using the inventive method, contrary to expectation: more than 95% of the alcohol component remains in the extracted material, the flavorings produced are virtually alcohol-free after their precipitation. The totality of the advantages could not be expected from the previously known experience of the prior art.

Preferably, the inventive method is carried out using compressed gaseous and/or supercritical C₂-C₄-hydrocarbons. The compressed C₂-C₄-hydrocarbons have a density which is greater than their respective density under standard conditions (T=0° C., p=101325 Pa), in particular at least 1% greater, more preferably at least 5% greater, still more preferably at least 10% greater, most preferably at least 50% greater.

Particularly advantageously, the method according to the present invention can be carried out at temperatures of ≦70° C., in particular ≦50° C., and ≧0° C., in particular ≧10° C., and pressures of <40 MPa, in particular <30 MPa, and >0.2 MPa, it having been found particularly expedient if the temperature is set at 20 to 35° C., and the pressure at 0.5 to 10 MPa.

Particularly suitable hydrocarbons have proved to be compressed ethane, propane, for example n-propane, isopropane, butane, for example n-butane, isobutane, tert-butane, or any desired mixtures thereof, the present invention also providing the use of entrainers such as dimethyl ether or alcohols which are then added to the hydrocarbons preferably in amounts of 0.5 to 50% by weight, preferably 2 to 20% by weight. Overall, a continuous process procedure is to be preferred.

From the number of starting materials coming into question, those having a liquid content ≧10% by weight, preferably ≧20% by weight, and in particular ≧30% by weight, and in particular pastes, purees, sludges, pressing residues and filtration residues and also aqueous and/or alcoholic liquids have been found to be particularly suitable, with those being considered to be particularly preferred being (fruit and vegetable) juices and waters produced in fruit and vegetable processing, such as lutter waters and condenser waters, alcoholic drinks and spirits, such as wine, rum and whisky and also brandies.

Liquid and semiliquid starting materials according to the present invention preferably have a dynamic viscosity of at least 0.01, in particular at least 0.1, and more preferably at least 0.5, and up to 100 000, in particular up to 10 000, and more preferably up to 1000 mPa·s, at 18° C.

Monophase, (semi)liquid means that the starting materials have only a single liquid phase in which if appropriate solids can be dispersed or present.

With respect to the volatile flavoring to be separated, the present invention comprises, in particular, natural, nature-identical and/or synthetic flavorings. Flavorings which are to be considered as particularly preferred in this context are those which are obtained in liquid or pasty form or as powder.

The volatile flavorings which can be separated by the inventive method have, in particular, a volatility which is greater than that of water, preferably greater than that of ethanol. The vapor pressure of the volatile flavorings at 20° C. is preferably ≧25 mbar, in particular ≧100 mbar, more preferably ≧200 mbar, preferably ≧300 mbar, and still more preferably ≧400 mbar.

The present invention also takes into account a special method variant in which the separated volatile flavorings are finally dissolved, which preferably takes place in alcohol.

As mentioned above, it is possible by means of the method according to the invention not only to separate volatile flavorings selectively as valuable product, but also to remove specifically from the starting materials volatile flavorings having an adverse aroma note. For this reason, the present invention also provides that the starting material is obtained in dearomatized and/or deodorized state, and thus enhanced in quality. The latter can readily be carried out in particular using appropriately suitable semiliquid melts, the fatty/oily constituent content of which has been set at ≦20% by weight.

With respect to the procedure, the present invention takes into account the fact that the claimed method is carried out in a separation column, preferably by the countercurrent principle, or else in another pressure vessel.

For separating the volatile flavorings, according to a further preferred method variant, the separation column can be coupled to a separator, and the extracted flavorings can preferably be separated by pressure reduction and/or temperature elevation.

Finally, the present invention also provides that the hydrocarbons used for separating the volatile flavorings are recirculated.

In summary, it remains to be stated that, by means of the inventive method, a method is provided for selectively separating volatile flavorings from semi-liquid or liquid starting materials, the oily and/or fatty components possibly present in the starting material not being separated off conjointly by means of the compressed hydrocarbons used, but remaining in the starting material. In this manner, firstly, flavorings are obtained in concentrated and very high quality form, but secondly, it is also possible to free the starting materials from flavorings which are perceived as adverse. In each case, high-grade products are obtained which can be used, in particular, in the food, pharmaceutical and cosmetics industries.

The possibilities resulting from the inventive method are of interest, especially:

For instance, for example typical volatile flavorings can first be separated from alcoholic drinks such as wine or beer, the remaining liquid can be freed from alcohol by conventional methods, and finally the typical flavorings can be added back to the de-alcoholized liquid.

However, it is also possible to prepare alcohol-free instant products, by removing from wine or champagne the flavorings and then mixing them together with flavorings which are obtained, for example, from orange juice, together with an effervescent powder. In this manner, a rapidly-dissolving and alcohol-free soft drink having the typical champagne/orange aroma is accessible.

Finally, mixed aromas can be selectively produced from cleaning and flushing waters which are produced in the cleaning of maturation and storage vessels, of beverage lines and bottling plants, and also in the washing and steaming of fruit and vegetables.

The present method for the selective separation of volatile flavorings from monophase, (semi)liquid starting materials having a fat content and/or oil content of ≦20% by weight is preferably carried out at temperatures of ≦70° C. and pressures of <50 MPa, in particular with the use of compressed ethane, propane, butane, or any desired mixtures thereof. Starting materials which come into question are pastes and purees having a liquid content ≧10% by weight, and also aqueous and/or alcoholic liquids, such as in particular juices and waters produced in juice production, but also alcoholic beverages and spirits. The natural, nature-identical and/or synthetic flavorings, in particular separated in this manner, are obtained in high sensory qualities. Furthermore, it is also possible by this method to free starting materials from unwanted flavorings, that is to deodorize them.

The examples hereinafter verify the described advantages of the inventive method for the selective separation of volatile flavorings.

### EXAMPLES

1. Separation of an Aroma of Blackcurrant from the Lutter Water of Blackcurrant

10 kg of lutter water from the production of concentrate of blackcurrant juice were extracted at 30 bar and 30° C. with a total of 10 kg of liquid propane in the column in countercurrent flow. The extract, after pressure reduction, was separated at 8 bar and 46° C., which produced 100 mg of an oily brown extract. This extract was dissolved in 100 g of absolute ethanol. The sensory properties of the dissolved extract found an odor typical of fruit which is identical to the aroma of blackcurrant juice.

Result of the Aroma Evaluation

Starting material: lutter water (typical odor)

Lutter water dearomatized: lactic, not identifiable and not definable

Extract diluted 1000-times: initially undefinable, hardwood-green note, after 2 to 3 minutes significant acidic aroma, after a longer time light-fruity, odor typical of fruit, aroma identical to juice

2. Separation of a Strawberry Aroma from Strawberry Juice

5 kg of strawberry juice having a musty cooked note and heavy sweetness (poor quality) were extracted at 35 bar and 30° C. with in total 3.5 kg of liquid propane in the column in countercurrent flow. The extract, after pressure reduction, was separated at 6 bar and 48° C., which produced 170 mg of a colorless, clear and oily extract. This extract was taken up in 10 g of absolute ethanol. The sensory evaluation found a typical strawberry aroma without heavy sweetness and without a cooked flavor. The aroma is very highly persistent, more intensive and purer than that of the strawberry juice.

Result of the Aroma Evaluation:

Starting material: over-stored juice: musty, cooked note, heavy sweet

Juice dearomatized: lactic, having slight strawberry odor

Extract, 50-times diluted: initially undefinable, then sweet-fruity, slightly woody (green), after 3 to 4 minutes increasingly fruit-typical without cooked taste, after 5 to 6 minutes typical strawberry without heavy sweetness, aroma very highly persistent; aroma better than that of strawberry juice

3. Separation of a Wine Aroma from Red Wine

8 kg of red wine were extracted at 30, bar and 25° C. with 5 kg of liquid propane in the column in countercurrent flow. The extract, after pressure reduction, was separated at 10 bar and 48° C., which produced 3.8 g of a low-viscosity, pale-green oil. This extract was dissolved in 100 g of absolute ethanol. The sensory properties of the dissolved extract were highly intense and pure-toned. The aroma assignment is unambiguous.

Result of the Aroma Evaluation:

Starting material: red wine from Spain (Navarra)

Extract 25-times diluted: identified as highly intense and pure-toned, bottling (typical odor after bottling plant)

1. A method for the selective separation of volatile flavorings from monophase, (semi)liquid starting materials having a fat content or oil content ≦20% by weight, wherein the method is carried out using compressed C₂-C₄-hydrocarbons.

2. The method as claimed in claim 1, conducted at a temperature of ≦70° C. and at a of <50 MPa.

3. The method as claimed in claim 2, wherein the temperature is set at 20 to 35° C. and the pressure at 0.5 to 10 MPa.

4. The method as claimed in claim 1, wherein compressed ethane, propane, butane or mixtures thereof are used.

5. The method as claimed in claim 1, wherein an entrainer is added to the compressed hydrocarbon.

6. The method of claim 1 that is carried out continuously.

7. The method of claim 1, wherein the starting materials having a liquid content of ≧10% by weight.

8. The method as claimed in claim 7, wherein juices, waters alcoholic drinks or spirits are used.

9. The method as claimed in claim 1, wherein natural, nature-identical or synthetic flavorings are obtained.

10. The method as claimed in claim 1, wherein the flavorings are in liquid, pasty form, or powder form.

11. The method as claimed in claim 1, wherein the flavorings are finally dissolved.

12. The method as claimed in claim 1, wherein the starting material is obtained in at least one of a dearomatized or deodorized state.

13. The method as claimed in claim 1, carried out in a separation column.

14. The method as claimed in claim 13, wherein the separation column is coupled to a separator, and the extracted flavorings are preferably separated by at least one of pressure reduction or temperature elevation.

15. The method as claimed in claim 13, wherein the hydrocarbons are recirculated.

16. The method of claim 5, wherein the entrainer is added in an amount of from 0.5 to 50% by weight.

17. The method of claim 5, wherein said entrainer is dimethyl ether or an alcohol.

18. The method of claim 16, wherein said entrainer is dimethyl ether or an alcohol.

19. The method of claim 7 wherein said starting materials are pastes, purees, sludges, pressing residues, filtration residues, an aqueous liquid or an alcoholic liquid.

20. The method as claimed in claim 14, wherein the hydrocarbons are recirculated.
